(19) United States
(12) Patent Application Publication
(10) Pub. No.: US 2023/0025320 A1
(43) Pub. Date: Jan. 26, 2023

(54) WEB WALLET

(71) Applicant: Unum ID, Inc., San Francisco, CA (US)

(72) Inventors: William Hale McCarty, Washington, DC (US); Jacob Singer, San Francisco, CA (US)

(21) Appl. No.: 17/870,603

(22) Filed: Jul. 21, 2022

Related U.S. Application Data
(60) Provisional application No. 63/224,458, filed on Jul. 22, 2021.

(51) Int. Cl. G06Q 20/38; G06Q 20/36

(52) U.S. Cl. CPC G06Q 20/3829; G06Q 20/36

(57) ABSTRACT

A digital identity wallet system includes a web wallet and Identity Cloud. The web wallet leverages browser APIs, platform authenticators, and secure device hardware to create, store, and use cryptographic keys. The Identity Cloud stores data encrypted on a per-user basis, so only a specific user can decrypt it, using the web wallet in a particular web browser, on a particular device. The web wallet, in conjunction with the browser and device, leverages cryptographic keys to perform all cryptographic operations locally. This allows the Identity Cloud to only handle sensitive data that's already been encrypted on a per-user basis before it receives it.

### RELATED APPLICATION(S)

This application claims priority under 35 U.S.C. § 119(e) of the co-pending U.S. Provisional Patent Application Ser. No. 63/224,458, filed Jul. 22, 2021, and titled “Web Wallet,” which is hereby incorporated by reference in its entirety.

### BACKGROUND

Digital wallets are applications that run on mobile phones, laptops, desktops, and other smart devices to securely store information such as credit cards, concert tickets, hotel reservations, driver's licenses, and passports, generally referred to as “credentials.” Credentials identify a party (referred to as a “holder” or “subject”) and verify a particular characteristic of the party, such as their address, bank account number, balance, etc.

As one example, the subject wishes to store credentials in their wallets and later share these credentials with third-parties such as merchants from whom they purchase goods, banks, with whom they transact business, government agencies, and the like. Preferably, when the subject wishes to share a verified credential with the merchant or other third party, she shares or presents only that portion needed for the transaction, a verified “presentation.” For example, if the credential contains a subject's name, address, email address, bank account number, and bank balance, the verified presentation may contain only the subject's name and an indication that the account contains sufficient funds to make the transaction. By limiting the information shared, the subject's information is protected.

As one example, an issuer digitally signs a document and sends it to the subject, who generates a verifiable presentation. The holder sends the verifiable presentation to a verifier. The subject can now send the verified presentation to a third-party requester. The verifier can also request information from the issuer before verification.

These traditional digital wallets have several drawbacks. First, they require users to download digital wallet applications onto their mobile phones or other smart devices. Many users are wary of downloading additional applications onto their mobile phones, unsure of the trustworthiness of the source of the application. Second, platforms storing the credentials may not adequately protect the credentials, in storage or in-transit, exposing the credentials to hackers and other third parties.

Accordingly, there is a need for technical solutions that address one or more of these needs, as well as other inefficiencies of the state of the art.

### SUMMARY

Systems in accordance with the disclosure provide several advantages over traditional digital wallets. First, these systems adequately protect data by storing and transmitting only end-to-end encrypted credentials or presentations (for simplification, unless otherwise indicated, generally referred to as credentials). The credentials are decrypted only on a holder's device or other trusted system using local cryptography.

Preferably, local cryptography is performed using platform authenticators and secure device hardware, an arrangement which has previously only been possible with native mobile applications. Systems in accordance with the embodiments decouple the storage of keys and data while ensuring that only the user can access their data in plaintext. Existing identity wallets typically store both keys and data on the same device, possibly exposing the data, the keys, or both to malicious third parties.

Advantageously, in accordance with the embodiments, the data repository (e.g., an Identity Cloud storing the encrypted data) never interacts with plaintext user data because the data is encrypted on a per-user basis. This encryption is separate from and in addition to standard encryption in transit and at rest. It prevents anyone except the user from decrypting the data. In other words, the data is “end-to-end” encrypted. The data repository, though it stores only encrypted data, still aggregates such data from all users in one place. Together with techniques like homomorphic encryption, this structure supports privacy-preserving data analytics with aggregation.

In a first aspect, a web wallet system includes a user device including a processor and a web browser. The web browser includes a web wallet application coupled to a storage component on the user device, the storage component containing a secret key set including a first private key. The web wallet application includes computer-readable media containing computer-executable instructions that when executed by the processor perform the steps: retrieving encrypted data from an Identity Cloud; retrieving from the storage component the first private key; decrypting the encrypted data on the user device using the first private key to generate clear-text data; sharing shared data corresponding to the clear-text data, the shared data derived from a credential.

In one embodiment, the steps further include generating the first private key on the user device and storing the first private key in the storage component. In one embodiment, the steps further include processing the clear-text data to generate the shared data before sharing the shared data. In one embodiment, processing the clear-text data includes signing the clear-text data with the first private key to generate signed data and encrypting the signed data with a third-party public key.

In one embodiment, the user device further includes a platform authenticator coupled to the web wallet application, wherein the storage component includes secure hardware coupled to the platform authenticator, the secure hardware containing the secret key set. Preferably, the secure hardware includes Secure Enclave or Secure Element, and the web application program includes a WebAuthn browser API.

In one embodiment, the storage component includes browser storage contained in the web browser, the browser storage includes HTML5 local storage, indexedDB, or both, and the web wallet application program comprises a WebCrypto browser API.

In yet another embodiment, the web wallet application includes both a WebAuthn browser API and a WebCrypto browser API.

In one embodiment, the steps further include transmitting a first public key corresponding to the first private key to the Identity Cloud.

In one embodiment, the user device contains one or more digital identity (ID) cards, and the shared data corresponds to presentations related to information contained in the digital ID cards.

Preferably, the secret key set contains multiple private keys, each of the multiple private keys mapped to a user device identifier and a browser on which the private key was created. Preferably, the web wallet system further includes an Identity Cloud coupled to the user device over the Internet, the Identity Cloud storing encrypted data on a per-user basis. In one embodiment, the encrypted data on the Identity Cloud includes encrypted credentials, encrypted presentations, or both.

Preferably, the user device is configured to transmit encrypted presentations to the Identity Cloud and to receive requests and encrypted credentials from the Identity Cloud.

In one embodiment, the Identity Cloud is configured to perform data aggregation, homomorphic encryption, or both.

In one embodiment, the web wallet system further includes a Server Software Development Kit (SDK) executing on a Customer Server and a Web SDK executing on a Customer Web client, wherein the Web SDK is coupled to the user device and the Server SDK, and the Server SDK is coupled to the Identity Cloud. In one embodiment, the Server SDK is configured to transmit encrypted credentials and requests to the Identity Cloud, and the Identity Cloud is configured to transmit encrypted presentations to the SDK Server. In still another embodiment, the Web SDK is configured to send request links to the user device.

Preferably, a logon to the web wallet system is passwordless.

In a second aspect, a method of sharing data stored on an Identity Cloud includes receiving encrypted data on a platform from an Identity Cloud, the data corresponding to a user credential; decrypting the data locally on the platform using a web wallet application and a private key stored in a secret key set on the platform; processing the decrypted data to generate processed data, the processed data for validating one or more characteristics in the credential; and sharing the processed data. Preferably, the processed data corresponds to a verified credential or a verified presentation. In one embodiment, the secret key set is stored in secure platform storage, and the method further includes authenticating a user identity on the platform before decrypting the data locally. In another embodiment, the secret key set is stored in secure browser storage.

In one embodiment, in response to a subject navigating to the platform, the method further includes transmitting a request link containing a parameter to the Identity Cloud, receiving from the Identity Cloud the request and related request information, and prompting the subject to respond to the request. In another embodiment, the data include a credential having an issuer signature, and the method further includes using a second private key to validate the issuer signature, generating a presentation object from the credential, signing the presentation object with the second private key, encrypting the presentation with a public key of a verifier, and transmitting the encrypted presentation object and verifier identifier to the Identity Cloud.

Preferably, the Identity Cloud stores encrypted data for multiple users on a per-user basis, as well as public keys on a per-user basis for authenticating requests for data stored on the Identity Cloud.

This summary is not an extensive overview of the present disclosure. It is not intended to identify key or critical elements of the present disclosure or to delineate the scope of the present disclosure. Its sole purpose is to present some embodiments of the present disclosure in a simplified form as a prelude to the more detailed description that is presented below.

### BRIEF DESCRIPTION OF THE DRAWINGS

Further advantages of the disclosure will become apparent by reference to the detailed description of preferred embodiments when considered in conjunction with the drawings. In the drawings, identical numbers refer to the same or a similar element. The drawings are intended to describe embodiments of the invention without limiting the scope of the disclosure.

FIGS. 1-7 show screenshots of a mobile phone display, illustrating a user logging into a web wallet system containing digital ID cards, navigating through the system, and sharing data with third parties, such as verifications, all in accordance with embodiments of the invention.

FIG. 8 shows the components of a system incorporating a web wallet in accordance with embodiments of the invention.

FIG. 9 shows the steps of a process for initializing a web wallet in accordance with embodiments of the invention.

FIG. 10 shows the steps of a process for sharing data using a web wallet in accordance with embodiments of the invention.

FIG. 11 shows a process flow and participants in verifying a presentation and paying an issuer using a web wallet in accordance with embodiments of the invention.

FIG. 12 shows the components of a digital web wallet system in accordance with embodiments of the invention.

FIGS. 13-16 show process flows for performing different transactions using a web wallet in accordance with embodiments of the invention.

### DETAILED DESCRIPTION

A digital identity wallet system in accordance with the disclosure is web based but still has comparable security to a mobile-based solution. These systems are passwordless and use hardware-backed cryptographic keys.

These systems allow separate organizations to issue digital ID cards to a user such that only that specific user can access the collection of data that the digital ID cards represent. It also allows still another organization to request and receive that data from the user with their full consent. In either case, the owner of the domain hosting the platform (e.g., including an Identity Cloud) never has access to the data itself

The system architecture is akin to a safety deposit box in a bank vault. The platform is analogous to the bank, with the vault corresponding to the database with enterprise-level security. Stored behind the locked vault door is not all the users' data in plain text, accessible to anyone who enters, but stored instead are the analog of a set of digital safety deposit boxes, where each safety deposit box can only be opened by one specific user, with their own unique cryptographic key. In this way, systems in accordance with the embodiments provide the technical infrastructure necessary for a digital identity wallet, without ever accessing the users' sensitive data.

In one embodiment, a digital identity wallet system includes a web wallet and an Identity Cloud. The web wallet leverages browser APIs, platform authenticators, and secure device hardware to create, store, and use cryptographic keys. The Identity Cloud stores data encrypted on a per-user basis so that only a specific user can decrypt the data by using the web wallet in a particular web browser, on a particular device.

In typical use in accordance with the disclosure, the Identity Cloud receives data from an external source that's per-user encrypted. Later, a user uses the web wallet (in a particular browser, on a particular device) to retrieve the encrypted data from the Identity Cloud. The web wallet then locally decrypts, processes, signs, and re-encrypts the data and sends it back to the Identity Cloud. The Identity Cloud then forwards the re-encrypted data to an external source.

The web wallet advantageously leverages cryptographic keys to perform all cryptographic operations locally, allowing the Identity Cloud to only handle sensitive data that's already been encrypted on a per user basis before it receives it.

The following detailed description is presented to enable a person skilled in the art to make and use the disclosure. For purposes of explanation, specific details are set forth to provide a thorough understanding of the present disclosure. However, it will be apparent to one skilled in the art that these specific details are not required to practice the disclosure. Descriptions of specific applications are provided only as representative examples. Various modifications to the preferred embodiments will be readily apparent to one skilled in the art, and the general principles defined herein may be applied to other embodiments and applications without departing from the scope of the disclosure. The present disclosure is not intended to be limited to the embodiments shown but is to be accorded the widest possible scope consistent with the principles and features disclosed herein.

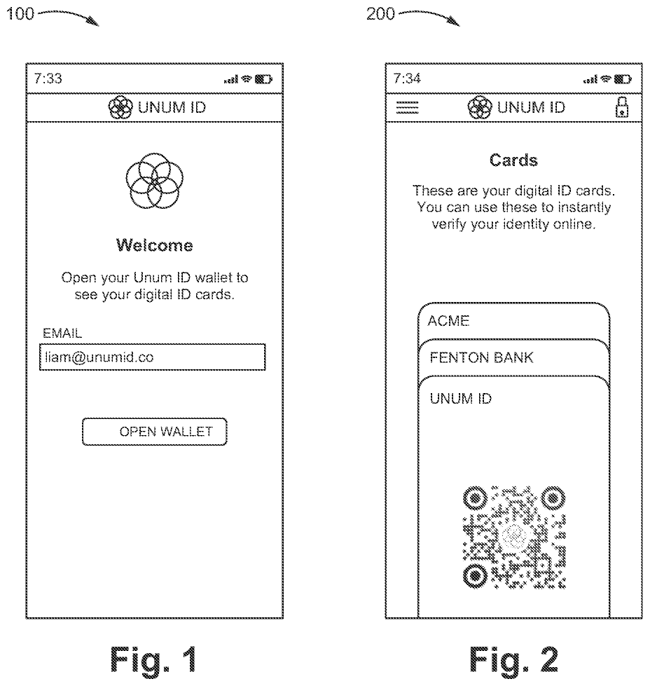

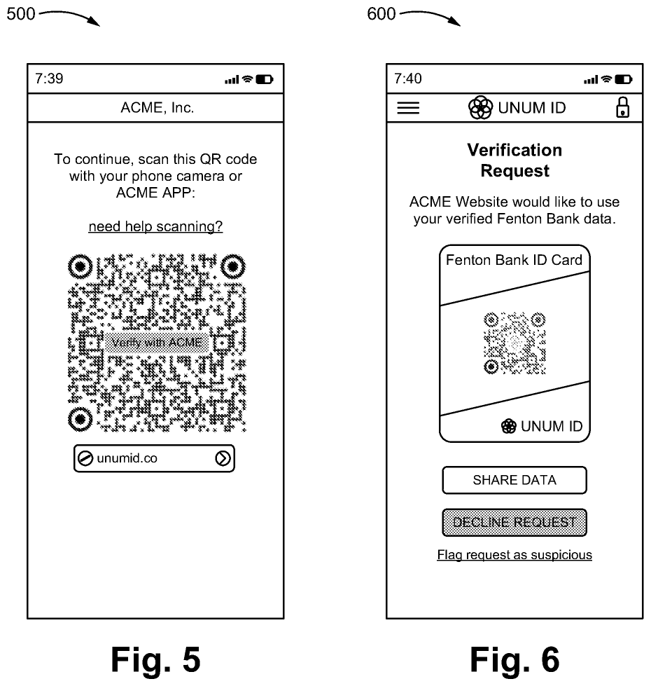

FIGS. 1-7 show screenshots of a user device for accessing a web wallet system in accordance with embodiments of the invention. The user device includes a web wallet application, such as described herein. FIG. 1 shows a user login screen 100 for logging onto the web wallet system. The login is passwordless, the login screen 100 prompting the user for only her email address. In other embodiments, the login may require other information, such as merely a username.

Preferably, from the login screen, a user inputs information (not shown) to authenticate their identity. In one embodiment, this information is entered on a platform authenticator, such as described below. In some embodiments, the platform authenticator includes a fingerprint scanner, a facial recognition scanner, or both, though other authentication structures, and combinations thereof, are also contemplated.

Once the user's identity is confirmed in this authentication step, the user is taken to a Cards screen 200, shown in FIG. 2, which lists all the digital User ID cards in the user's digital wallet, issued by different companies. As explained in more detail below, the User ID cards are used to share data between companies. The User ID cards in Cards screen 200 include (1) an ACME ID card, for scanning government or other agency documents, such as a driver's license or passports, to prove the user's identity, (2) a Fenton Bank ID Card, and (3) an Unum ID card, which, among other things, encodes verified emails using the web wallet system, such as descried below.

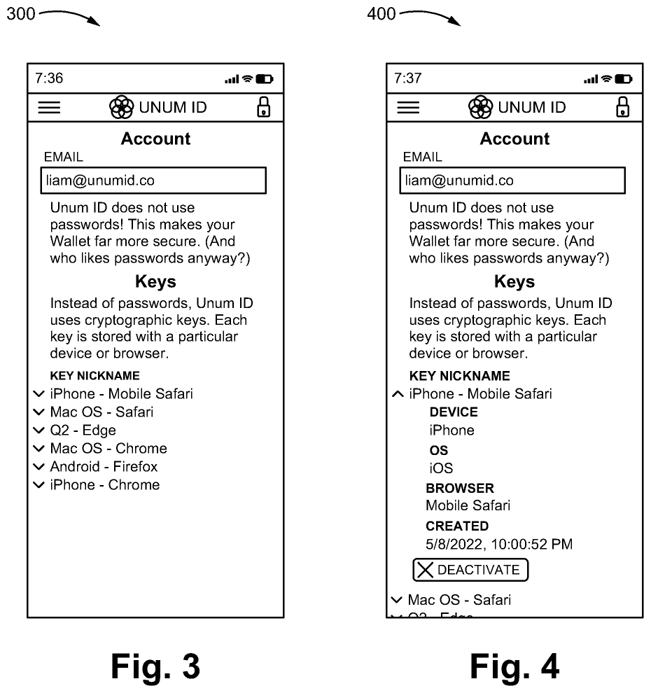

From the screen 200, the user can navigate to the Account screen 300 shown in FIG. 3. The Account screen 300 displays the user's email address (entered in the screen 100) and the cryptographic keys stored on particular devices or browsers from which the user can access her web wallet. The Account screen 300 shows the nicknames for cryptographic keys stored on each of these devices or browsers:
iPhone—Mobile Safari
MAC OS—Safari
Q2—Edge
MAC OS—Chrome
Android—Firefox
iPhone—Chrome

FIG. 4 shows a screenshot 400 when the “iPhone—Mobile Safari” entry is expanded to display the Device (iPhone), Operating System (iOS), Browser (Mobile Safari), and the creation date of the key (May 18, 2022).

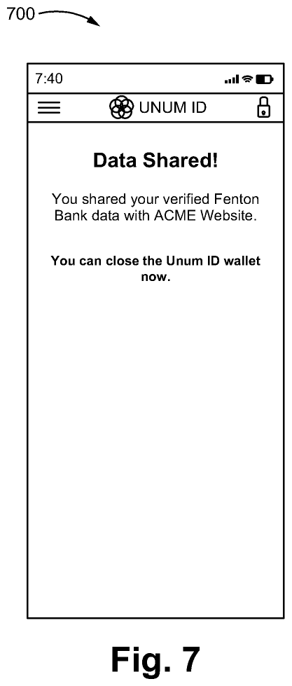

At the Cards screen 200, the user can select a company with which to share data. In this example, the user has chosen to share data with ACME company. In response to this selection, the user is presented with a QR code from ACME, as shown in the screen 500 in FG. 5. Once the user scans the QR code on ACME's web site, the user is presented with a Verification Request screen 600 shown in FIG. 6, in which she is prompted for her verified email address with the prompts “Share Data” and “Decline Request.” If the user selects “Share Data,” the data is shared with ACME, and the user is presented with the Data Shared screen 700, shown in FIG. 7, acknowledging that the data was shared.

As explained above, the data is shared by downloading the encrypted data, decrypting the data locally using the user's private key, signing the data, re-encrypting the signed data using the verifier's public key, and sharing the signed data, such that the data can be decrypted using the verifier's private key to generate a verified presentation.

In one embodiment, a web wallet system uses the following specific technologies:
WebAuthn browser API, to generate and use ECC secp256r1 key pairs using platform authenticators and secure device hardware. In one embodiment, WebAuthn is used only for what it was designed for (authentication), and WebCrypto is used to cryptographically sign structured data. In another embodiment, WebAuthn is used beyond what it was designed for, modified in accordance with the embodiments to cryptographically sign structured data. Embodiments accomplish this by replacing the random challenge passed to the device hardware with other data (or a hash of that data). This expands the use of WebAuthn from purely authentication to general cryptographic signing.
WebCrypto browser API, to generate and use 2048-bit RSA keys and store them with HTML5 localStorage and indexedDB. These are used for local encryption and decryption.

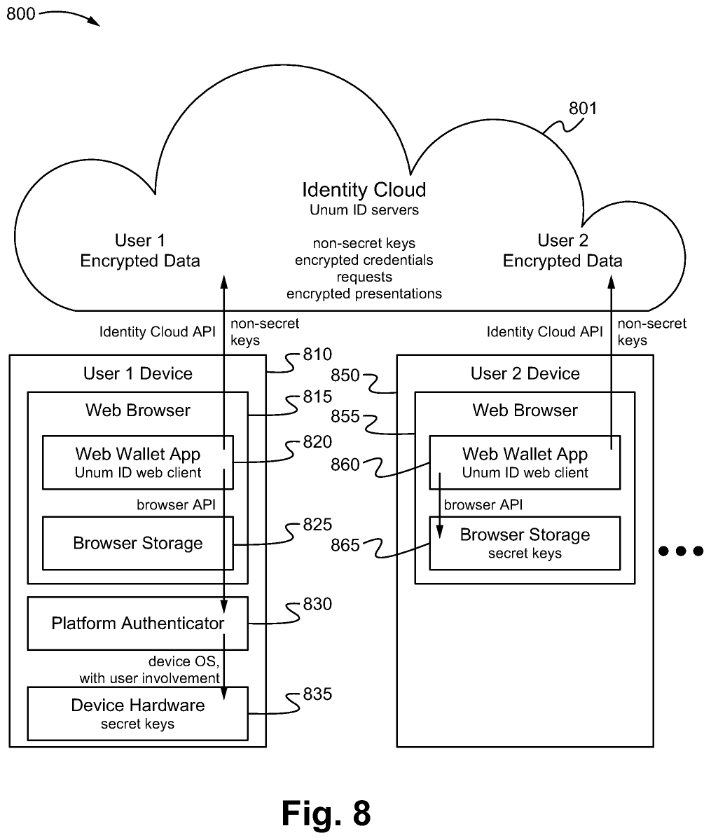

FIG. 8 shows a web wallet system 800 in accordance with embodiments, including user devices 810 and 850 having some functionally equivalent component parts (e.g., elements 815 and 855, 820 and 860, and 825 and 865). The exemplary user 1 device 810 includes a web browser 815 having browser storage 825 and a web wallet application 820 coupled to a platform authenticator 830, which in turn is coupled to device hardware 835. The device hardware 835 is configured to store multiple private keys. The web wallet application 820 includes application program interfaces (APIs) to create, store, and use cryptographic keys in a particular browser, on a particular device. The web wallet application is coupled to an Identity Cloud 801, with which it exchanges data that have been encrypted on a per-user basis.

As illustrated by user 2 device 850, embodiments of the invention are also able to operate on user devices that do not include a platform authenticator and device hardware. For example, user 2 device 850 does not include a platform authenticator and device hardware, such as included on the user 1 device 810. The user 2 device 850 stores secret keys in the browser storage 865.

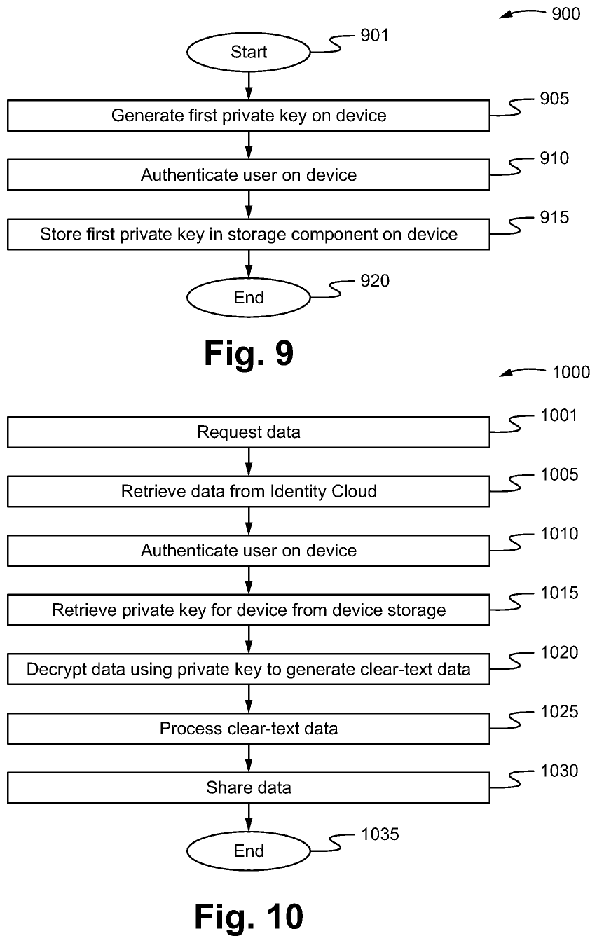

FIG. 9 is a high-level flow chart 900 showing the steps of a process for initializing a user device, such as user 1 device 810, including a web wallet application, in accordance with embodiments of the invention. As one example, the web wallet application 815 includes a WebAuthn browser API to generate and use secret key pairs, such as ECC secp256r1 key pairs.

Referring to FIGS. 8 and 9, initialization of the user 1 device 810 begins in a step 901. Next, in a step 905, the WebAuthn browser API generates a first private key. Next, in a step 910, the platform authenticator 830 verifies the identity of the user. Next, in a step 915 the web wallet application 820 stores the private key in the device hardware 835. In a step 920, the process ends.

It will be appreciated that in some embodiments the user 2 device 850 is initialized differently than the user 1 device 810. When initializing the user 2 device 850, the authentication step 910 is not performed. In accordance with these other embodiments, the step 905 is performed using WebCrypto browser API, and in the step 915, the private key is stored in the web browser storage 865.

As one example, when the device 810 is an iPhone or other Apple device, the device hardware includes secure storage including a Secure Enclave. Alternatively, when the device 810 is an Android device, the secure storage includes a Secure Element. It will be recognized that the secure storage can include other structures in accordance with embodiments of the invention depending, for example, on the manufacturer and type of the device 810 or 850.

As explained in more detail below, in some embodiments, the user device stores one or more private keys in a secret key set. As shown in the Account screen 300 in FIG. 3, a user device in accordance with the embodiments can store multiple keys each mapped to both the device on which it was created and the browser used to create it.

While the examples generally describe using private keys, preferably, keys are generated, stored, and used as private-public key pairs.

FIG. 10 is a high-level flow chart 1000 showing the steps of a process for sharing data associated with a digital web wallet in accordance with embodiments of the invention. Referring to FIGS. 8 and 10, in a step 1001, the web wallet application 820 requests data from the Identity Cloud 801. As explained above, the Identity Cloud 801 stores the data in an encrypted form. Next, in a step 1005, the web wallet application 820 retrieves the encrypted data from the Identity Cloud 801. Next, in a step 1010, the web wallet application 820 triggers the platform authenticator 830 to authenticate the user on the user device 810. If the user is authenticated, in a step 1015, the private key corresponding to the encrypted data is retrieved from the device hardware 835, and in a step 1020 the private key is used to decrypt the encrypted data locally, on the user device 810, to generate clear-text data. Next, in a step 1025, the clear-text data is processed to generate processed data on the user device. As one example, the data is processed by generating a presentation, signing the presentation with the private key, and encrypting the signed data with a third-party public key, such as a public key of the intended recipient of the verified credential or verified presentation, thereby generating shared data. Next, in a step 1030, the shared data is transmitted to the Identity Cloud 801. In a step 1035, the process ends.

It will be appreciated that the process 1000 is different when performed on the user 2 device 850. In that case, the authentication step 1010 is not performed, and, in the step 1015, the private key is retrieved from the browser storage 865.

In one embodiment, the user devices 810 and 850 each includes one or more processors and computer-readable media that contain computer-executable instructions that when executed by the one or more processors execute the steps 900 and 1000 in FIGS. 9 and 10, respectively.

It will be appreciated that the steps of the processes are merely illustrative. In other embodiments, the steps are performed in different orders, some steps can be added, and other steps can be deleted. For example, in some embodiments, depending on the party with whom the data is shared and the type of data being shared, data are not signed before being shared.

Those skilled in the art will recognize other sequences of key creation, key retrieval, data encryption and decryption, and data signing and authentication, among other possible data flows, such as used in the examples below.

### Uses of Digital Identity Wallets

As described above, digital identity wallets are used in a variety of applications, including data sharing services and data aggregators, all of which, as described below, overlap.

### Digital Identity Wallets

Current digital identity wallets fall into three main categories:
1. web applications that require shared secrets to operate,
2. mobile applications, and
3. dedicated hardware products.

As used herein, the term “shared secrets” refers to any piece of information shared between a user and a data provider, or between a user and an application. Examples include passwords, passcodes, PINs, secret backup phrases, one-time passcodes, time-based authenticator codes, knowledge based authentication answers, etc.

All of these categories have significant security and/or usability drawbacks that the embodiments improve on. For example, wallets in category (1) are vulnerable to social engineering attacks and have high friction user experiences due to their reliance on shared secrets. Wallets in category (2) require the addition of mobile SDKs to mobile apps that users already have installed or require new installation of dedicated apps, both of which are difficult steps for companies and users to take. Wallets in category (3) have low adoption from everyday users and suffer from incompatibilities with many systems.

### Data Sharing Services

Current data sharing services fall into two main categories:
1. services that use shared secrets for other companies' accounts that users provide, and
2. services that use a passthrough model for data provided by other companies.

Services in category (1) ask users to provide shared secrets for other companies, e.g., their bank passwords. These services store and use these shared secrets to authenticate to other companies on each user's behalf and harvest data that they then sell access to. This usually requires approaches like screen scraping that don't directly involve the companies from which the data is harvested.

Services in category (2) work directly with companies that provide data and have users authenticate to those companies individually. These services use a passthrough model, where companies providing data send that data in plaintext (apart from standard encryption in transit and at rest) to the service, which stores it temporarily (or in some cases permanently), sells access to it, and routes it to the company paying for that access.

Both of these categories involve significant costs to security and user privacy, since user secrets and plaintext user data are collected into honeypots vulnerable to attack and misuse. To date, there has been no technical way to avoid these problematic approaches without creating untenable user experiences. Systems in accordance with the embodiments provide an option that is extremely secure and private and yet also maintains a simple user experience.

### Data Aggregators

Current data aggregators source and pool large amounts of data about people (and things) and sell access to the data itself and other data derived from it. In existing architectures, that data may be encrypted in transit and at rest but is still able to be decrypted by the aggregator, making it extremely vulnerable to breach and misuse. There has to date been an unavoidable tradeoff between gaining the value of data when analyzed en masse and causing dramatic security and privacy problems, data breaches and identity theft as prominent examples. Systems in accordance with the embodiments avoid any central storage of sensitive data that could ever be accessed in plaintext and yet maintain the ability to analyze it in aggregate, through emerging techniques like multi-party fully homomorphic encryption.

### Scenarios Using Digital Identity Wallets

Digital identity wallets in accordance with embodiments of the invention interact with other components in an identity system. The different interactions require that the digital wallet perform different functions of the web browser, including the web wallet application. To help explain these different functions, a description of credentials generation and verification for sharing data are included, to illustrate what a web wallet in accordance with the embodiments does.

The following sections describe participants, components, operations, and flows in typical uses scenarios that use digital wallets in accordance with the embodiments.

### Participants

There are three types of participant:
issuer,
subject, and
verifier.

All participants leverage various cryptographic keys, generated and used with components described below.

FIG. 11 shows a flow 1100 sharing data between an issuer 1101 and a subject 1105, between the subject 1105 and a verifier 1110, and between the verifier 1110 and the issuer 1101. In the flow 1100, the issuer 1101 issues a credential to the subject 1105. The subject 1105 verifies the data, such as by generating a presentation to the verifier 1110, which then authorizes payment to the issuer 1101.

In different embodiments, the presentation may include a subset of the credential. For example, if the verifier needs only to verify that a user has the required funds to make a payment, only the indication that the user has the required funds is presented. Other information, such as a credit card number, is not included as part of the presentation.

### Issuer

An issuer issues credentials to subjects. To do this, an issuer:
generates cryptographic keys with an Server SDK (Software Development Kit, described in more detail below),
stores private keys somewhere (e.g. in a database),
sends public keys to the Identity Cloud, and
uses private keys by passing them to the Server SDK.

To register an issuer:
1. The customer registers an issuer and receives an issuer API key.
2. The customer installs the Server SDK on its server.
3. The customer passes its issuer API key to the register function in the Server SDK.
4. The Server SDK creates signing and encryption key pairs, returns the private keys to the customer server, and sends the public keys to the Identity Cloud.

To issue a credential to a subject:
1. The customer passes credential data, a private key, and a subject identifier to the issue credential function in the Server SDK.
2. The Server SDK creates a credential object, signs the credential with the private key, encrypts the credential with a public key of the subject's, and sends the encrypted credential and subject identifier to the Identity Cloud.
3. The Identity Cloud stores the encrypted credential for the subject.

### Subject

A subject uses one or more holders to retrieve requests (created by verifiers) from the Identity Cloud, retrieve encrypted credentials (issued by issuers) from the Identity Cloud, and share encrypted presentations with the Identity Cloud (to be sent to verifiers). As used herein, a holder is the Web Wallet in a particular browser, on a particular device. To do this, a subject:
uses a holder to generate cryptographic keys using the browser, leveraging device hardware if possible;
uses a holder to store private keys in device hardware if possible and otherwise in the browser;
uses a holder to send public keys to the Identity Cloud; and
uses a holder to use private keys with browser APIs, leveraging device hardware if possible.

To register a holder:
1. The subject opens a holder for the first time.
2. The holder creates cryptographic keys (leveraging device hardware and platform authenticators if possible), stores the private keys in device hardware if possible and otherwise in the browser, and sends the public keys to the Identity Cloud.

To retrieve a request:
1. The subject navigates to a holder using a request link (generated by a verifier).
2. The holder sends a parameter in the request link to the Identity Cloud, which returns the request and additional request information.
3. The holder prompts the subject to respond to the request.

To share a presentation:
1. The subject decides to share a presentation (whether or not in response to a request).
2. The holder prompts the subject to pass a platform authenticator test, if possible.
3. The holder retrieves encrypted credentials from the Identity Cloud. (If responding to a request, it sends the credential requests to the Identity Cloud, which responds with matching credentials.)
4. The holder uses the browser to decrypt the credentials, leveraging the device hardware if needed.
5. The holder uses the browser to check the issuer signature on each credential.
6. The holder creates a presentation object, signs the presentation with a private key, encrypts the presentation with a public key of the verifier, and sends the encrypted presentation and verifier identifier to the Identity Cloud.
7. The Identity Cloud sends the encrypted presentation to the verifier.
8. The holder receives the verification result from the Identity Cloud and displays it to the subject.

### Verifier

A verifier creates and sends requests (for presentations) to subjects and verifies presentations shared by subjects. To do this, a verifier:
generates cryptographic keys with the Server SDK,
stores private keys somewhere (e.g. in a database),
sends public keys to the Identity Cloud, and
uses private keys by passing them to the Server SDK.

To register a verifier:
1. The customer registers a verifier and receives a verifier API key.
2. The customer installs the Server SDK on its server.
3. The customer passes its verifier API key to the register function in the Server SDK.
4. The Server SDK creates cryptographic keys, returns private keys to the customer server, and sends public keys to the Identity Cloud.

To create a request (for a presentation):
1. The customer passes request data and a private key to the create request function in the Server SDK.
2. The Server SDK creates a request object, signs the request with the private key, and sends the request to the Identity Cloud.
3. The Identity Cloud stores the request until a holder retrieves it for a subject and returns a request link to the customer server.

To share a request link with a subject:
1. The customer uses the Web SDK on a web client to display or sends the request link to the subject. This involves some communication channel (e.g., QR code or button display, message sent over push notification, SMS, or email, etc.).

To verify a presentation shared by a subject:
1. The Identity Cloud sends an encrypted presentation to the customer server.
2. The customer server passes the encrypted presentation to the verify function in the Server SDK.
3. The Server SDK decrypts the presentation, checks the subject signature, checks the issuer signature on each credential, checks that the credentials match the request, checks that the credentials have valid statuses, checks that the presentation includes the correct verifier identifier, and returns a verification result to the customer server.
4. The customer server returns the verification result to the Identity Cloud, which passes it to the holder.

### Components

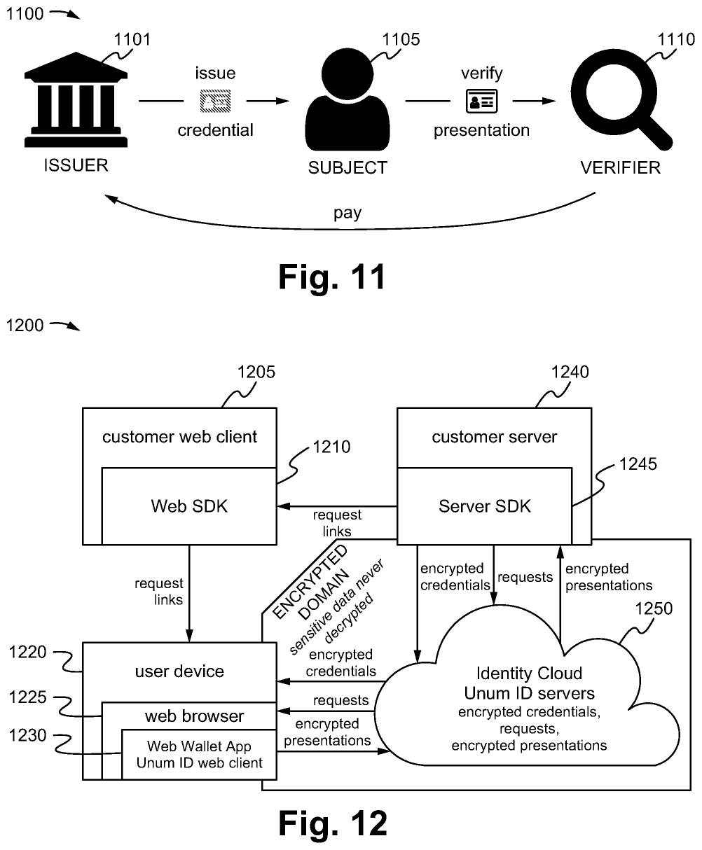

FIG. 12 shows a digital wallet identity system 1200 in accordance with one embodiment. The system 1200 includes (1) a Server SDK (or Server API) 1245, a component of a Customer Server 1240, (2) a Web SDK 1210, a component of a Customer Web client 1205, (3) a Web Wallet Application 1230, included as a component of a web browser 1225, which in turn is included in a user device 1220, and (4) an Identity Cloud 1250. As explained in more detail below, the Server SDK 1245 sends encrypted credentials and requests to the Identity Cloud 1250, which sends the credentials and requests to the Web Wallet Application 1230. The Server SDK 1245 sends request links to the Web SDK 1210, which in turn sends the request links to the Web Wallet Application 1230. The Web Wallet Application 1230 sends encrypted presentations to the Identity Cloud 1250, which sends the encrypted presentations to the Server SDK 1245.

In some embodiments, each of the components, the Customer Web Client 1205, the user device 1220, the Customer Server 1240, and the Identity Cloud 1250, contains one or more processors and computer-readable media containing computer-executable instructions to perform the steps in the steps and flows described herein. As some examples, the computer-executable instructions can be executed on one or more of the components, or distributed among the components.

The components are now described in more detail below.

### Server SDK

In accordance with one embodiment, a customer installs the Server SDK 1245 on its server and uses it to act as an issuer and/or verifier. It can also use the Server API instead. The difference between the two is that the SDK enables local creation, storage, and use of private keys. This, among other things, ensures that all sensitive data is encrypted prior to being sent to the Identity Cloud 1250 and is decryptable only by a specific participant. The Server API cannot enable this, as all data must be sent in plaintext (apart from standard encryption in transit and at rest).

In some embodiments, the Server SDK 1245 sends encrypted credentials and requests to the Identity Cloud 1250, receives encrypted presentations from the Identity Cloud 1250, and sends requests for links to the Web SDK 1210.

### Web SDK

A customer adds the Web SDK 1210 to its web client 1205 and uses it to display and/or send request links to subjects.

In some embodiments, the Web SDK 1210 receives requests for links from the Server SDK 1245 and sends requests for links to the user device 1220.

### Web Wallet

Preferably, the web wallet application 1230 is run by the owner of the web wallet system and hosted at a domain controlled by the owner. As one example, the Identity Cloud 1250 is a Unum ID Server, hosted by Unum ID of San Francisco, California. In other embodiments, the web wallet application 1230 is run by and hosted on a domain controlled by a party that can ensure secure access to the system. The web wallet application 1230 leverages browser APIs and device hardware to securely create, store, and use private keys for subjects. Preferably, this is accomplished by ensuring control of the domain. When possible, the web wallet application 1330 uses platform authenticators to validate user presence. Private keys are stored in device hardware when possible and otherwise in secure browser storage.

In some embodiment, the web wallet application 1230 sends encrypted presentations to the Identity Cloud 1250.

Here, a “holder” is defined as the Web Wallet in a particular browser, on a particular device. This is because a holder is what “holds” cryptographic keys. Those keys are stored in device hardware and secure browser storage, so the definition preferably includes both the particular device and the particular browser.

In some embodiments, on some platforms, keys can be used in a cross-platform way. For example, a user can use the same WebAuthn key across any browser on a particular device. Those skilled in the art will recognize other modifications and features in accordance with the embodiments.

### Identity Cloud

The Identity Cloud receives encrypted credentials from issuers, stores them for subjects, and returns them to holders (used by subjects). It receives requests from verifiers, returns request links to verifiers, and returns request information to holders. It receives encrypted presentations from holders (used by subjects), sends them to verifiers, and returns verification results to holders.

In some embodiments, the Identity Cloud 1250 receives encrypted credentials and requests from the Server SDK 1245, sends encrypted presentations to the Server SDK 1245, sends encrypted credentials to the user device 1220, sends requests to the web browser 1225, and receives encrypted presentations from the web wallet application 1230.

### Operations

A web wallet system in accordance with embodiments can perform several operations, including operations of a holder, that is, the Web Wallet and the particular browser and device it's running on. A Web Wallet in accordance with the embodiments performs four main operations:
key creation
key storage
key use
interactions with the Identity Cloud

Secret keys are created, stored, and used, leveraging device hardware and platform authenticators when possible and, otherwise, using native functions.

As some examples, the Identity Cloud stores non-secret keys, encrypted credentials, requests, and encrypted presentations.

As used herein, the term “key” refers to a cryptographic key, whether asymmetric or symmetric. Some are “secret keys” like private asymmetric keys or symmetric ones. Others are “non-secret keys” like public asymmetric keys.

### Key Creation

The Web Wallet uses browser APIs to create cryptographic keys, leveraging secure device hardware and platform authenticators when possible.

As used herein, the term “secure device hardware” refers to dedicated hardware elements that are typically isolated from the rest of the device and only loosely tied to the operating system. Prominent examples are the Secure Enclave on iOS devices and the Secure Element on Android devices, both of which enable creation and use of key pairs where the private key never leaves the secure hardware and is accessible to no one, not even the device manufacturer.

As used herein, the term “platform authenticators” refers to device tools that leverage secure hardware and additional data like biometrics and passcodes to authenticate users. Prominent examples are Touch ID and Face ID on Apple devices, which process biometric data using the Secure Enclave.

In accordance with embodiments, key creation includes, but is not limited to, the following examples:

using the WebAuthn API to create ECC secp256r1 key pairs in the Secure Enclave of an iOS phone, and using the WebCrypto API to create 2048-bit RSA keys.

### Key Storage

In accordance with embodiments, a web wallet uses browser APIs to store cryptographic keys, leveraging secure device hardware when possible.

This includes, but is not limited to, the following examples:
using the Secure Element of an Android phone to store ECC secp256r1 private keys, which the Element does by default for any key pairs that are created,
using the browser's HTML5 localStorage to store 2048-bit RSA private keys and AES keys, and
using the browser's indexedDB to store 2048-bit RSA private keys and AES keys.

### Key Use

In accordance with embodiments, a web wallet uses browser APIs to use cryptographic keys for creating and checking signatures and encrypting and decrypting data, leveraging secure device hardware and platform authenticators when possible.

This includes, but is not limited to, the following examples:
using the WebCrypto API to validate cryptographic signatures on credentials and requests,
using the WebCrypto API to decrypt credentials and encrypt presentations, using the WebAuthn API to authenticate with private keys, and
using the WebAuthn API to cryptographically sign blocks of data (whether structured, hashed, or otherwise).

### Interactions with the Identity Cloud

In accordance with embodiments, a web wallet uses an API to interface with the Identity Cloud to retrieve requests, retrieve encrypted credentials, check the status of credentials, share encrypted presentations, receive the results of verifications, receive aggregate data, and more.

### Flows

This section describes a typical flow through a digital identity system in accordance with embodiments of the invention. In summary:
1. Issuer issues credential to subject.
2. Verifier creates request.
3. Verifier shares link with subject.
4. Subject uses holder to share presentation, and verifier verifies it.

The figures below are “black box” diagrams in the sense that they hide details internal to components and focus only on the interactions between them.

### 1. Issuer Issues Credential to Subject.

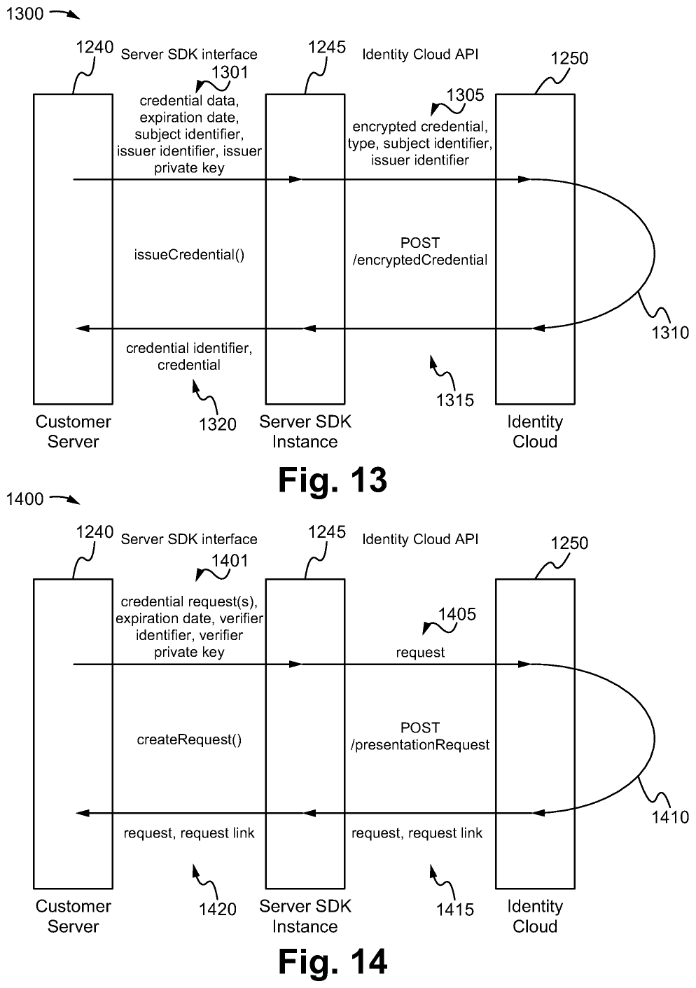

FIG. 13 illustrates a process flow 1300 in accordance with the embodiments, showing a customer acting as an issuer using a Server SDK instance to send an encrypted credential to the Identity Cloud, which stores it for a subject.

Referring to FIGS. 12 and 13, in a step 1301, the Customer Server 1240 passes credential data, expiration date, subject identifier, issuer identifier, and issuer private key to the issue credential function of the Server SDK 1245 interface. Next, in a step 1305, the Server SDK 1245 passes the encrypted credential, type, subject identifier, and issuer identifier to the POST encrypted credential endpoint of the Identity Cloud 1250 API. Next, in a step 1310, the Identity Cloud 1250 receives and stores the encrypted credential. Next, in a step 1315, the Identity Cloud 1250 returns to the Server SDK 1245. And in a step 1320, the Server SDK 1245 returns the credential identifier and credential to the Customer Server 1240.

### 2. Verifier Creates Request

FIG. 14 illustrates a process flow 1400 in accordance with the embodiments, showing a customer acting as a verifier (either the same one acting as an issuer or a different one) using a Server SDK instance to send a request to the Identity Cloud, which stores it until a holder retrieves it for a subject.

Referring to FIGS. 12 and 14, in a step 1401, the Customer Server 1240 passes credential request(s), expiration date, verifier identifier, and verifier private key to the create request function of the Server SDK 1245 interface. Next, in a step 1405, the Server SDK 1245 passes the request to the POST presentation request endpoint of the Identity Cloud 1250 API. Next, in a step 1410, the Identity Cloud 1250 receives and stores the request. Next, in a step 1415, the Identity Cloud 1250 returns the request and request link to the Server SDK 1245. Next, in a step 1420, the Server SDK 1245 returns the request and request link to the Customer Server 1240.

3. Verifier Shares Link with Subject.

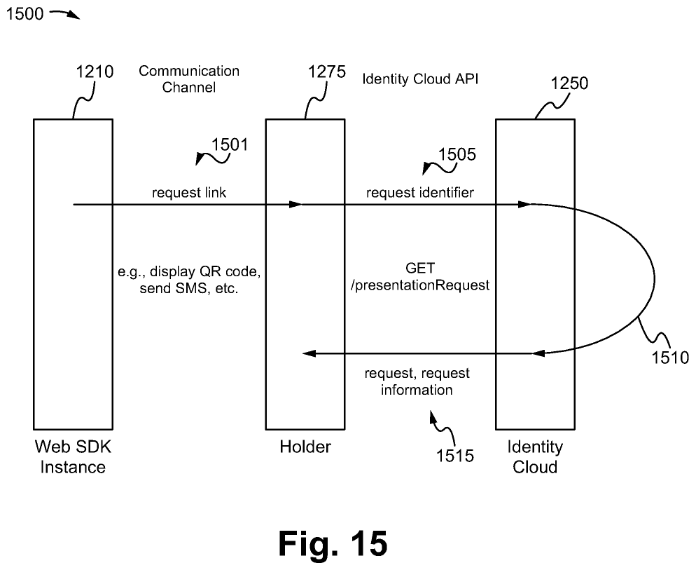

FIG. 15 illustrates a process flow 1500 of a customer acting as a verifier using a Web SDK instance to share the link with a subject. The subject uses the link to open a holder, which retrieves the request from the Identity Cloud. In the examples below, a “holder” is defined as the web wallet in a particular browser, on a particular device.

Referring to FIGS. 12 and 15, in a step 1501, the customer's Web SDK 1240 instance displays or sends the request link to a subject, who uses it to navigate to a holder. (This could involve, e.g., a displayed QR code or sent SMS message.) Next, in a step 1505, the holder parses the request identifier from the request link and passes it to the GET presentation request endpoint of the Identity Cloud 1250 API. Next, in a step 1510, the Identity Cloud 1250 receives and processes the request identifier. Next, in a step 1515, the Identity Cloud 1250 returns the request and request information to the holder.

### 4. Subject Uses Holder to Share Presentation, and User Verifies It.

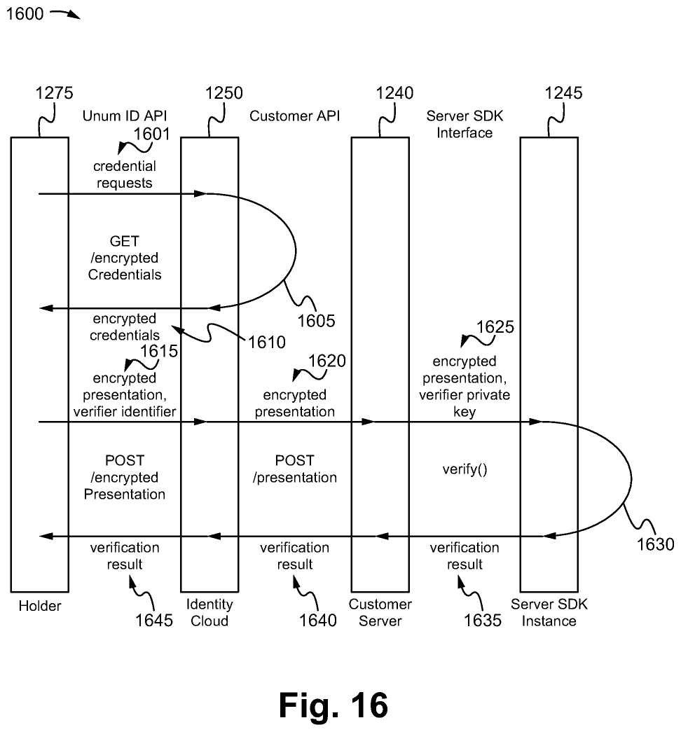

FIG. 16 illustrates a process flow 1600 where a subject uses the holder to share a presentation, and the user verifies the presentation. The subject chooses to share a presentation, and the holder retrieves encrypted credentials (that match the credential requests) from the Identity Cloud. The holder decrypts these and checks the issuer signature on each of them. It then creates and sends an encrypted presentation to the Identity Cloud, which sends it to the customer acting as a verifier, which uses a Server SDK instance to verify the presentation.

Referring to FIGS. 12 and 16, in a step 1601, the holder 1275 passes credential requests (if applicable) to the GET encrypted credentials endpoint of the Identity Cloud 1250 API. Next, in a step 1605, the Identity Cloud 1250 receives and processes the credential requests. Next, in a step 1610, the Identity Cloud 1250 returns encrypted credentials to the holder. Next, in a step 1615, the holder 1275 passes the encrypted presentation and verifier identifier to the POST encrypted presentation endpoint of the Identity Cloud 1250 API. Next, in a step 1620, the Identity Cloud 1250 passes the encrypted presentation to the POST presentation endpoint of the Customer Server 1240 API. Next, in a step 1625, the Customer Server 1240 passes the encrypted presentation and verifier private key to the verify function of the Server SDK 1245, and in a step 1630, the Server SDK 1245 verifies the presentation. Next, in a step 1635, the Server SDK 1245 returns the verification result to the Customer Server 1240, and in a step 1640, the Customer Server 1240 returns the verification result to the Identity Cloud 1250. Next, in a step 1645, the Identity Cloud 1250 returns the verification result to the holder 1275.

In operation of one embodiment, a platform such as a user device includes a web wallet application that stores one or more secret key pairs on the platform, preferably in secure storage accessible by a platform authenticator, or alternatively, in browser storage. In response to request to share data, the web wallet application receives encrypted data stored on an Identity Cloud, locally decrypts the data on the platform, and shares the data. In some embodiments, if the platform supports a platform authenticator test, the platform prompts a subject to pass a test before the decrypting the data. In other embodiments, the platform decrypts the data, such as a credential, checks the issuers signature, creates a presentation object, signs the presentation with a private key, encrypts the presentation with a public key of a verifier, and transmits the encrypted presentation and verified identity to the Identity Cloud.

The disclosure includes flow charts and process flows. In different embodiments, the components described above include processors, computer-readable media containing computer-executable instructions that when executed by the processor perform the steps of the flow charts and process flows.

While the disclosure has been described with respect to a limited number of embodiments, those skilled in the art, having benefit of this disclosure, will appreciate that other embodiments can be devised which do not depart from the scope of the disclosure as disclosed herein, as defined by the appended claims.

What is claimed is:

1. A web wallet system comprising:
a user device comprising
a processor; and
a web browser comprising:
a web wallet application coupled to a storage component on the user device, the storage component containing a secret key set comprising a first private key, the web wallet application comprising computer-readable media containing computer-executable instructions that when executed by the processor perform:
retrieving encrypted data from an Identity Cloud;
retrieving from the storage component the first private key;
decrypting the encrypted data on the user device using the first private key to generate clear-text data; and
sharing shared data corresponding to the clear-text data, the shared data derived from a credential.

2. The web wallet system of claim 1, wherein the processor further performs:
generating the first private key on the user device; and
storing the first private key in the storage component.

3. The web wallet system of claim 2, wherein the processor further performs processing the clear-text data to generate the shared data before sharing the shared data.

4. The web wallet system of claim 3, wherein processing the clear-text data comprises signing the clear-text data with the first private key to generate signed data.

5. The web wallet system of claim 4, wherein generating the shared data comprises encrypting the signed data with a third-party public key.

6. The web wallet system of claim 1, wherein the user device further comprises a platform authenticator coupled to the web wallet application, wherein the storage component comprises secure hardware coupled to the platform authenticator, the secure hardware containing the secret key set.

7. The web wallet system of claim 6, wherein the secure hardware comprises Secure Enclave or Secure Element.

8. The web wallet system of claim 7, wherein the web application program comprises a WebAuthn browser API.

9. The web wallet system of claim 1, wherein the storage component comprises secure browser storage contained in the web browser.

10. The web wallet system of claim 9, wherein the secure browser storage comprises HTML5 local storage, indexedDB, or both.

11. The web wallet system of claim 10, wherein the web application program comprises a WebCrypto browser API.

12. The web wallet system of claim 1, wherein the processor further performs transmitting a first public key corresponding to the first private key to the Identity Cloud.

13. The web wallet system of claim 1, wherein the user device contains one or more digital identity (ID) cards, and the shared data corresponds to presentations related to information contained in the digital ID cards.

14. The web wallet system of claim 13, wherein the secret key set contains multiple private keys, each of the multiple private keys mapped to a user device identifier and browser on which the private key was created.

15. The web wallet system of claim 1, further comprising an Identity Cloud coupled to the user device over the Internet, the Identity Cloud storing encrypted data, encrypted on a per-user basis.

16. The web wallet system of claim 15, wherein the encrypted data on the Identity Cloud comprise encrypted credentials, encrypted presentations, or both.

17. The web wallet system of claim 15, wherein the user device is configured to transmit encrypted presentations to the Identity Cloud and to receive requests and encrypted credentials from the Identity Cloud.

18. The web wallet system of claim 15, wherein the Identity Cloud is configured to perform data aggregation, homomorphic encryption, or both.

19. The web wallet system of claim 15, further comprising:
a Server Software Development Kit (SDK) executing on a Customer Server; and
a Web SDK executing on a Customer Web client,
wherein the Web SDK is coupled to the user device and the Server SDK, and the Server SDK is coupled to the Identity Cloud.

20. The web wallet system of claim 19, wherein the Server SDK is configured to transmit encrypted credentials and requests to the Identity Cloud, and the Identity Cloud is configured to transmit encrypted presentations to the SDK Server.

21. The web wallet system of claim 19, wherein the Web SDK is configured to send request links to the user device.

22. The web wallet system of claim 1, wherein logging on the web wallet system does not require a password.

23. A method of sharing data stored on an Identity Cloud, the method comprising:
receiving encrypted data on a platform from an Identity Cloud, the data corresponding to a user credential;
decrypting the data locally on the platform using a web wallet application and a private key stored in a secret key set on the platform;
processing the decrypted data to generate processed data, the processed data for validating one or more characteristics in the credential; and
sharing the processed data.

24. The method of claim 23, wherein the processed data corresponds to a credential or a presentation.

25. The method of claim 25, wherein the secret key set is stored on the platform in secure platform storage.

25. method of claim 25, further comprising authenticating a user identity on the platform before decrypting the data locally.

27. The method of claim 23, wherein the secret key set is stored in secure browser storage.

28. The method of claim 23 wherein, in response to a subject navigating to the platform, the method further comprising:
transmitting a request link containing a parameter to the Identity Cloud;
receiving from the Identity Cloud the request and related request information; and
prompting the subject to respond to the request.

29. The method of claim 23, wherein the data comprise a credential having an issuer signature, the method further comprising:
using a second private key to validate the issuer signature;
generating a presentation object from the credential;
signing the presentation object with the second private key;
encrypting the presentation with a public key of a verifier; and
transmitting the encrypted presentation object and verifier identifier to the Identity Cloud.

30. The method of claim 23, wherein the Identity Cloud stores encrypted data for multiple users on a per-user basis.

31. The method of claim 23, wherein the Identity Cloud further stores public keys on a per-user basis for authenticating requests for data stored on the Identity Cloud.
